(19) United States
(12) Patent Application Publication
(10) Pub. No.: US 2019/0021525 A1
(43) Pub. Date: Jan. 24, 2019

(54) WEIGHTED COMFORTER

(71) Applicant: Kathrin Hamm, Nufringen (DE)

(72) Inventor: Kathrin Hamm, Nufringen (DE)

(21) Appl. No.: 15/921,679

(22) Filed: Mar. 15, 2018

(30) Foreign Application Priority Data
Jul. 24, 2017 (DE) 202017104394.0

(51) Int. Cl. A47G 9/02; B32B 5/02; B32B 7/08; B32B 7/04; B32B 3/06; B32B 3/26

(52) U.S. Cl. CPC A47G 9/0223; B32B 5/022; B32B 7/08; B32B 7/045; B32B 2262/04; B32B 3/26; B32B 2262/062; B32B 2250/40; B32B 3/06

(57) ABSTRACT

The invention relates to a weighted comforter for improving the sleep quality, having a blanket, which includes a number of weights in the interior of the blanket, wherein air channels, which increase the breathability and moisture absorbency of the blanket, are formed in the blanket, wherein a plurality of layers is provided in the blanket.

### CROSS REFERENCE TO RELATED APPLICATIONS

The present application claims the benefit of German Utility Model Application No. 20 2017 104 394.0 filed on Jul. 24, 2017. All the above are hereby incorporated by reference.

The invention at hand relates to a weighted comforter for improving the sleep quality. The weighted comforter is to combine the function of a traditional weighted comforter and the associated calming effect of weights on the body with the comfort of a common comforter or duvet. Duvet is a different term for comforter.

Difficulties in sleeping can be caused by various factors, such as, e.g. serotonin imbalance, insomnia, fear, stress, attention deficit hyperactivity syndrome (ADHS), restless leg syndrome (RLS), autism and various other geriatric and psychiatric conditions.

The concept of the weighted blankets is based on the alleviation of various geriatric and psychiatric conditions and is also widespread in occupational therapy. Weighted blankets exert a pressure on the body of the patient and help him to relax and to fall asleep.

A therapeutic blanket comprising weights in the form of incorporated chains is already known from DE 202009019127. A weighted duvet, which is provided with weights on an end region, is already known from US 2006/0016005 A1. A weighted duvet, in the case of which the weights are incorporated into an edge of the blanket, is known from US 2006/0174410 A1. US 20110047698 A1 discloses a weighted duvet, in the case of which the weights limit a movement of the weight filling in the blanket. Lastly, a weighted pillow, which can be provided with devices, which allow for a sensory notification or input, whereby this weighted pillow is to be placed onto the thighs in order to obtain alleviation in the case of restless leg syndrome (RLS), is already known from US 2009/0149698 A1.

However, more recent studies also emphasize the positive effects of weighted duvets on the sleep quality and the general well-being of healthy adults. Studies show a longer sleep time, longer deep sleep phases and a shorter time to fall asleep. As a whole, the sleep becomes calmer and subjects report improved well-being as well as more energy throughout the day.

For the most part, conventional weighted comforters, which focus on alleviating geriatric and psychiatric conditions, are only conditionally suitable for use as comforter. Conventional designs have been characterized as overheating the body temperature while sleeping, due to the weights and distribution across the full surface area of the blanket, restricting their usability to shorter time periods due to the heat accumulation and limited air-circulation throughout the comforter. Conventional designs are also characterized by one-layer, large square pockets, which are filled with the weighted materials, which range from glass beads, polymers, gel fillings to therapy balls and weighted metal chains. In the following, examples for glass beads, polypropylene or polyethylene are mentioned but not limited thereto.

Common weighted comforters are thus characterized by weighted sample structures and the filling materials are clearly visible through the textile layer. In particular the filling material should thereby often be well noticeable, which is to promote an alleviation of sensory disorders, in particular in the case of autism. The focus on feeling the weights is associated with disadvantages for the natural adaptation of the blanket to the human body shape, the breathability and air circulation. The handling of the blanket is also made more difficult due to large pockets, because a weight filling can move in the pockets when handling the blanket.

It is the object of the invention at hand to specify a weighted comforter with increased sleep comfort by improved air circulation, better moisture management, and an evenly weight distribution with an increased surface area contact of the weights.

This object is solved by means of a weighted comforter according to claim 1.

The weighted comforter according to the invention combines the function of a traditional weighted comforter and the associated calming effect of weights on the body with the comfort of a common comforter.

It is preferred that 9 layers are formed in the blanket, which results in a special circulation.

It is preferred that a core layer is formed in the blanket, which has air channels and weight channels parallel to the length of the blanket, wherein the weight channels include a number of weights. By alternating air and weight channels, the breathability of the blanket and moisture absorbency is increased, while the weights are held evenly in position and are distributed in elongated pockets across the blanket. The weighted comforter includes a plurality of layers.

In one embodiment of the weighted comforter, a core layer is formed in the blanket, which has air channels perpendicular to a length and a width of the blanket. In this embodiment, the air channels provide a ventilation through the blanket. This embodiment further comprises weight channels, which run parallel to the length and or width of the blanket, wherein the weight channels include a number of weights. In one version, the weight channels run in the longitudinal direction, parallel to a length of the blanket. A further embodiment comprises weight channels, which run in the cross direction parallel to a width of the blanket. This embodiment can also be designed in such a way that the weight channels result in an intersecting grid, between which the air channels extend through the blanket. In this embodiment, the air channels are much shorter and allow for an air and moisture exchange directly through the blanket, perpendicular to the main expansion directions of the blanket. The air channels are hereby preferably made of a highly air-permeable material, woven fabric or of a netting. This also allows for a good air exchange through the weighted comforter, in particular in the summer, without the person having to move much below the blanket. In the case of crossed weight channels, the latter can be connected to one another, so that a double height of the weight channels is not created at the crossing points. Provision is likewise made to arrange the weight channels in a hexagonal or honeycomb pattern, respectively, in the core layer, whereby an improved manageability of the blanket and an improved ventilation and an improved weight channel to ventilation channel ratio can be reached. Provision is thereby made for the further layers, which can be arranged above and below the core layer, to also be provided with ventilation channels or air-permeable materials, respectively (at least at the locations of the ventilation channels), in order to provide for a good air exchange.

Additionally, through dividing the pocket in weight and air channels the quadratic shape of the traditional weight pockets changes into a rectangular shape, which increases the surface contact area between the body and the blanket, thereby increasing the pressure effect of the weight.

It is preferred that the weight channels have two cotton layers with a length of 15-25 cm and a width of between 6.5 and 10.5 cm, and that the air channel has a width of between 0.1, 10 and 3.10 cm.

It is preferred that the weight channels and air channels in each case be sewn together so as to adjoin one another by means of the connection of the upper and lower cotton layer.

It is preferred that the air channels ensure an air circulation in the entire blanket, while they exert pressure on the weight channels, whereby the weights remain distributed evenly and a movement of the weights is prevented at the same time.

It is preferred that the blanket include 10-18 air channels, which extend through the entire length of the blanket and that it includes 10-18 weight channels, which are divided in the width by horizontal seams, whereby a plurality of weight pockets is formed.

It is preferred that each weight channel be filled with glass beads or filling material polypropylene or polyethylene.

It is preferred that 35 to 51 grams or 35 to 128 grams of polypropylene or polyethylene or 35 to 128 grams of glass-beads be included in each weight pocket or channel.

It is preferred that the two outer layers in each case have a non-woven material, respectively, cellulose as filling material as well as a shell of lycocell or cotton.

It is preferred that the outer layer also be stitched in longitudinal channels, wherein a longitudinal channel of the external view has a width of approximately 10 cm, so that each longitudinal channel covers a weight and air channel.

The invention will be described in more detail below by means of schematic figures of specific embodiments.

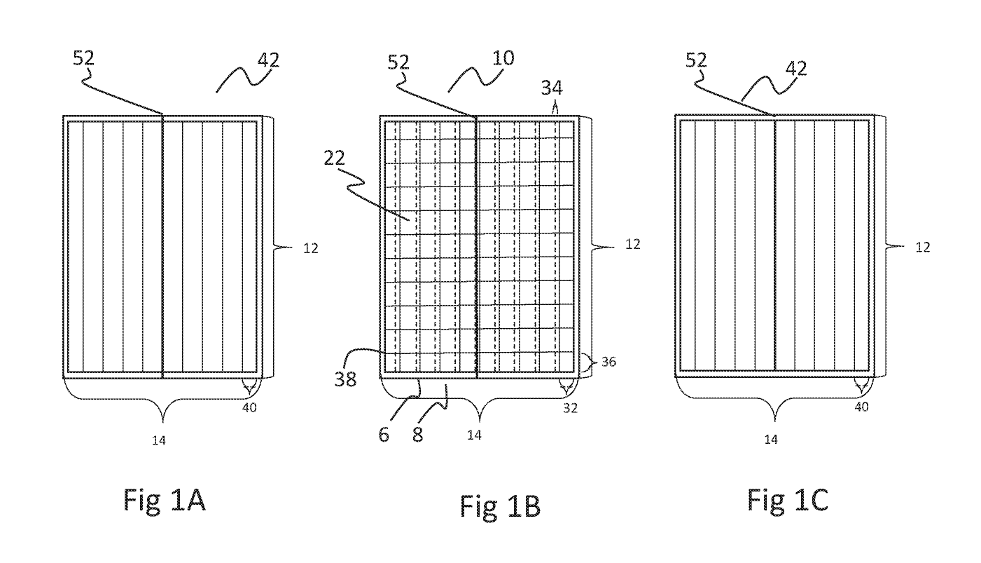

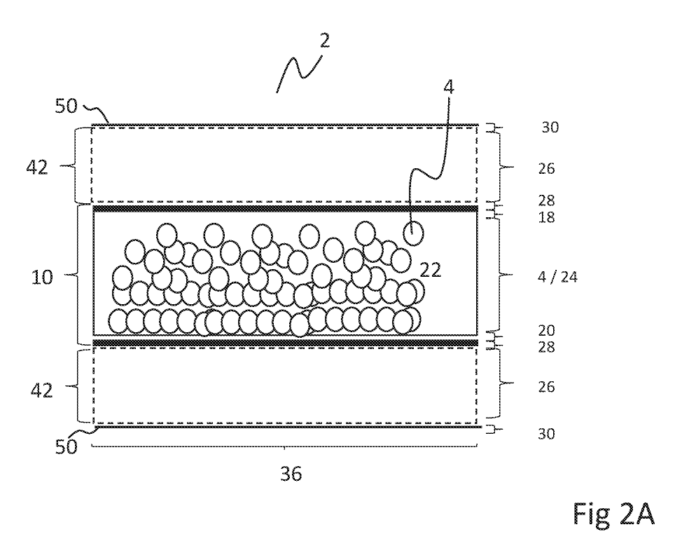

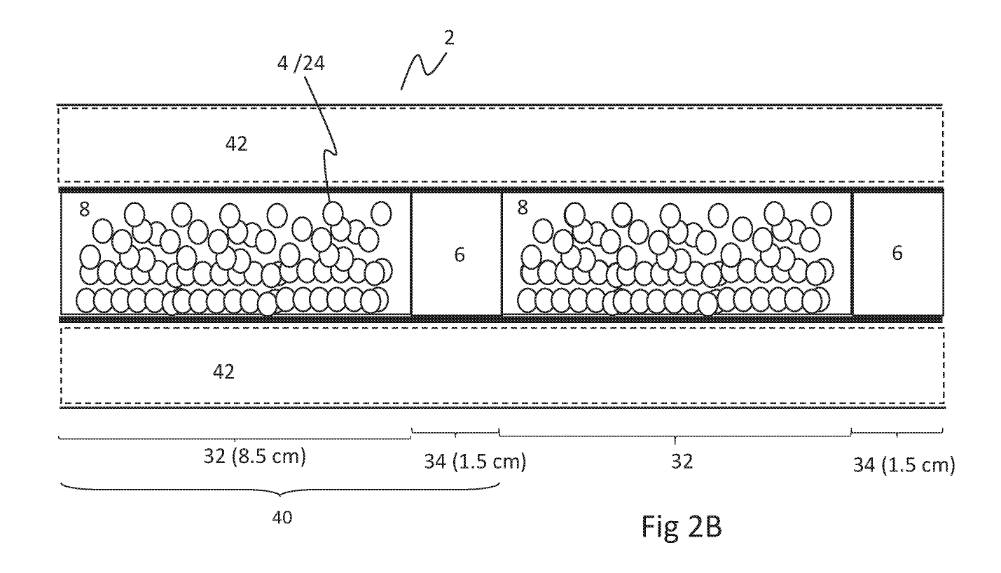

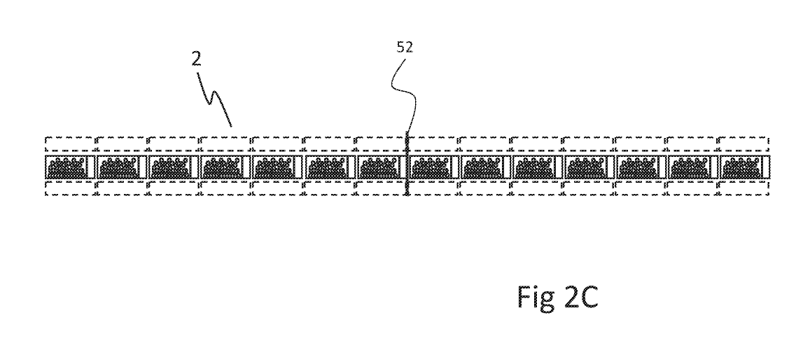

FIGS. 1A to 2C show different partial views and partial and partial sectional views of a weighted comforter according to the invention at hand.

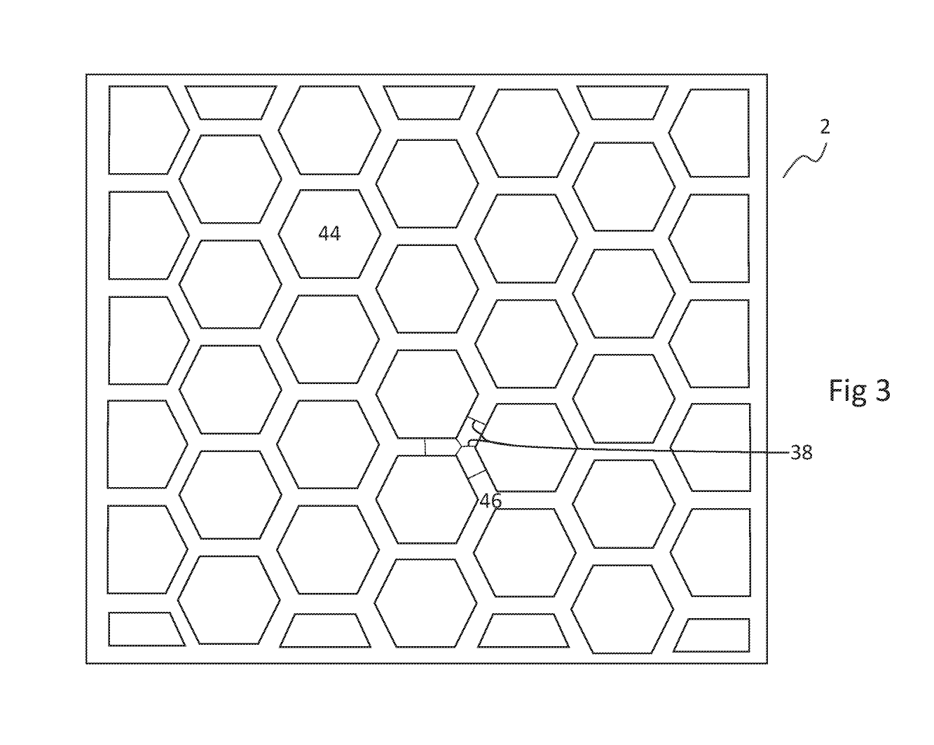

FIG. 3 represents a further embodiment of a weighted comforter comprising a hexagonal structure.

In the drawing as well as in the description, identical or similar reference numerals will be used below in order to refer to identical or similar components or elements.

FIGS. 1A to 1C in each case show a top view onto one of the three main parts of the weighted comforter 2 according to the invention, an upper cover or upper outer layer 42, a lower cover or lower outer layer 42, as well as a core layer 10 comprising weight elements or weights 4, respectively. The weighted comforter, i.e. the core layer 10, the outer layers 42 and optional the cover 50 can have a width 14 of for example 135 cm and a length 12 of 200 cm.

FIG. 1A shows an upper outer layer 42 in a top view. The outer layer is divided into longitudinal channels comprising a width by means of seams. Provision can be made in the middle of the outer layer 42 for a zipper 52, by means of which the blanket or the outer layer 42, respectively, can be divided into two parts in a longitudinal direction. The outer layer can be provided with a circumferential hook and loop fastener, so as to connect the outer layer(s) 42 to a core layer 10. On the edge, outer layers and core layer are sewn with a piping.

The outer layer is provided with longitudinal channels 40, which run in the longitudinal direction across the outer layer 42. A width of the longitudinal channels can be adapted to width dimensions of weight and ventilation channels of the core layer 10.

FIG. 1B shows a core layer 10 of the weighted comforter comprising air channels 6 and weight channels 8, which run parallel to the length 12 of the blanket. The channels are in each case formed of two cotton layers 18, 20 with a length 36 of 20 cm. The weight channels have a width 32 of 8.5 cm and the air channels have a width 34 of 1.5 cm. The weight channels are divided into individual weight pockets 22 by means of stitched seams.

FIG. 1C corresponds exactly to FIG. 1A and will thus not be described once again.

FIG. 2A shows a sectional view through the weighted comforter in the longitudinal direction of a weight channel. The weighted comforter 2 comprises three layers, the outer layers 42 and the core layer 10, which, in turn, are in each case divided into three sublayers. The weighted comforter 2 furthermore also comprises a cover 50 of lycocell 30, which wraps the entire weighted comforter. The outer layers 42 in each case comprise two layers of a non-woven material or of a fleece material 28, respectively, which are connected to one another and which are filled with a cellulose filling material 26 in the embodiment at hand. The core layer 10, in the case of which an upper cotton layer 18 and a lower cotton layer 20 enclose weights 4 in the form of the filling material of glass beads, polypropylene or polyethylene 24, e.g. in particle form or in a particulate form, respectively, is arranged between the outer layers 42. The weight channel 8 extends along the entire longitudinal direction of the weighted comforter 2 and can be divided into individual weight pockets 22 by means of separating walls or stitched seams 38. The weight pockets 22 prevent that the weights 4 or also the polypropylene, polyethylene or the glass beads filling 24 can shift too much in the longitudinal direction. The weight pocket 22 has a length of 20 cm.

Analogous to FIG. 2A, FIG. 2B shows a sectional view through the weighted comforter in the transverse direction of the blanket through two weight channels 8 and two air or ventilation channels 6. The layer structure of the outer layers 42 corresponds to that of FIG. 2A. The weight channels 8 are cut in the transverse direction and thus have a smaller width 32 of 8.5 cm than in the longitudinal direction. In the shown section, two weight pockets 22 are illustrated, which are separated by an air channel 6. Here, the air channels 6 correspond to the weight channels, but only have a width 34 of 1.5 cm and are not filled. The air channels can be divided into air pockets in the transverse direction by means of stitched seams. It is preferred, however, that the air channels 6 extend along the entire length 12 of the weighted comforter 2. It can be seen in the cross section that the outer layers 42 are also divided in the transverse direction by means of stitching or stitched seams. Longitudinal channels 40 are formed in the outer layer 42 by means of the stitching. Here, the weighted comforter is set up in such a way that the sum of the width 32 (8.5 cm) of a weight channel 8 and of the width 34 (1.5 cm) of an air channel 6 of the core layer 10 corresponds to the width of a longitudinal channel 40 (10 cm) of the outer layers 42. It can thus be attained that the structure of the outer layers 42 corresponds to the structure of the core layer 10. In the illustrated embodiment, the core layer and the outer layers are in each case three-layered, and the weighted comforter is additionally surrounded by two lycocell 30 layers of the cover 50. This embodiment thus has 9 layers. The lycocell layer is connected to the fleece and non-woven as outer layer.

The weight channels 8 and air channels 6 are sewn adjacent to one another by the connection of the upper cotton layer 18 and lower cotton layer 20. The air channels 6 ensure an air circulation in the entire weighted comforter 2 at least in the core layer 10, while they exert pressure on the weight channels, whereby the filling weights 4 of glass beads, polypropylene or polyethylene particles remain distributed evenly and the movement of the filling material 24 is prevented at the same time. The blanket includes 14 air channels 6, which move through the entire length 12 of the blanket 2 or the core layer 10, respectively, and 14 weight channels 8, which are divided by horizontal seams in the width, whereby a total of up to 140 weight pockets 22 are formed.

Each weight channel 8 or each weight pocket 22, respectively, is filled with the filling material glass beads, polypropylene or polyethylene 24. Depending on the weight category ranges between 35 to 128 grams, in particular 43 grams of polypropylene, polyethylene or glass-beads filling 24 are located in each weight pocket 22. The used glass-beads filling 24 in the form of glass sand or the used polypropylene or polyethylene filling 24 in the form of balls can also be washed at 95 degrees (Celsius) and adapts well to the textiles due to the round shape of the individual weight elements 4.

The two outer layers 42 in each case comprise a non-woven fabric 28, a cellulose filling material 26, as well as a lycocell 30 cover 50. They are also stitched in longitudinal channels 40 and in each case blanket a width of a weight channel 8 and air channel 6 at a width of 10 cm per longitudinal channel 40 (mentioned in FIG. 2C). By means of this interaction of the widths of the channels in the core layer and the outer layers, the function of a comforter is reflected to the outside, and the appearance of the filling material can no longer be recognized from the outside.

As shown in FIG. 2C, this structure also provides for an improved mobility, which is associated with the intricacy of design of the connection of the weights and air channels. The blanket can be folded and washed, and the zipper in the center provides for an easier handling of blanket parts, which in each case weigh only half of the core layer. The separation through the zipper also allows to combine two different weight categories within one comforter to adjust for the different body weights if two people use the comforter, guaranteeing the optimization of pressure effects as stated in the medical literature which attributes 10% body weight to be effective

FIG. 3 represents a top view onto a weighted comforter 2, in the case of which the weight channels form a grid 46 of weight channels. Perpendicular air channels 44, which allow for an air exchange through the blanket, are formed in the spaces between the grid, The grid 46 of weight channels is divided by means of stitched seams 38 for dividing the weight channel into individual weight pockets, in order to prevent a movement of the weight filling inside the blanket. It can also be ensured by means of the stitched seams that the blanket can adapt well to a person, who lies underneath it. It goes without saying that triangular grids or square grids are also possible instead of hexagonal grids.

The inner core of the comforter may be manufactured by providing two fabrics on top of each other and applying seams in a longitudinal direction to form channels. Air channels may be filled with means for providing air flow, weight channels may be filled with filling material after sewing the seams.

Alternatively single channels may be pre-sewn and a plurality of these separate channels are laterally arranged and sewn together, thus forming the inner core of the comforter reaching to its extent. Advantageously, means for providing air flow and filling material may be inserted into the channels either before or after sewing the channels together, thus providing the option of facilitating the manufacturing process.

The air channels, which are provided e.g. in a aforementioned manner, may be supported by inserted tubes, preferably made of a soft material, to prevent collapse of the volume in an air channel and/or to prevent closing/sealing of the air channel by orthogonal stitch seaming. Alternatively a meshed tubes may be used, which further allows radial flow/entry of air into the tube. Further alternatively air-permeable tubes may be used for the same purpose.

### LIST OF REFERENCE NUMERALS

2 weighted comforter
4 weights
6 air channels
8 weight channels
10 core layer
12 length of the blanket
14 width of the blanket
16 height of the blanket
18 upper cotton layer
20 lower cotton layer
22 weight pocket
24 filling material glass beads, polypropylene or polyethylene
26 filling material cellulose
28 non-woven material or fleece, respectively
30 lycocell
32 width of a weight channel
34 width of an air channel
36 length of a weight pocket
38 stitched seam for dividing the weight channel into individual weight pockets
40 width of a longitudinal channel
42 outer layer
44 perpendicular air channels
46 grid of weight channels
48 weight filling
50 cover
52 zipper

1. A weighted comforter for improving the sleep quality, having a blanket, which includes a number of weights in the interior of the blanket, wherein air channels, which increase the breathability and moisture absorbency of the blanket, are formed in the blanket, wherein a plurality of layers is provided in the blanket.

2. The weighted comforter according to claim 1, wherein 9 layers are formed in the blanket.

3. The weighted comforter according to claim 1, wherein a core layer, which has air channels and weight channels parallel to the length of the blanket, is formed in the blanket, wherein the weight channels include a number of weights.

4. The weighted comforter according to claim 1, wherein a core layer, which has air channels perpendicular to a length and a width of the blanket, and which has weight channels, which run parallel to the length and or a width of the blanket, is formed in the blanked, wherein the weight channels include a number of weights.

5. The weighted comforter according to claim 1, wherein the weight channels have two cotton layers with a length of 15-25 cm and a width between 6.5 and 10.5 cm, and the air channel has a width of between 0.85 and 2.25 cm or 1.10 and 3.10 cm.

6. The weighted comforter according to claim 1, wherein the weight channels and air channels in each case are sewn together so as to adjoin one another by means of the connection of the upper and lower cotton layer.

7. The weighted comforter according to claim 1, wherein the air channels ensure an air circulation in the entire blanket, while they exert pressure on the weight channels, whereby the weights remain distributed evenly and a movement of the weights is prevented at the same time.

8. The weighted comforter according to claim 1, wherein the blanket includes 10 to 18 air channels, which extend through the entire length of the blanket, and 10 to 18 weight channels, which are divided in the width by horizontal seams, whereby a plurality of weight pockets is formed.

9. The weighted comforter according to claim 1, wherein each weight channel is filled with the filling material glass beads, polypropylene or polyethylene.

10. The weighted comforter according to claim 1, wherein 35 to 51 grams or 35 to 128 grams of glass beads, polypropylene or polyethylene are included in each weight pocket.

11. The weighted comforter according to claim 1, wherein the two outer layers in each case have a non-woven material or fleece, respectively, cellulose as filling material as well as a cover of lycocell.

12. The weighted comforter according to claim 1, wherein the cover is also stitched in longitudinal channels and preferably cover the weight and air channel unit with 10 cm per channel.

13. The weighted comforter according to claim 1, wherein provisions are made in the middle of the outer layer for a zipper, by means of which the blanket or the outer layer, respectively, can be divided into two parts in a longitudinal direction.

14. The weighted comforter according to claim 8, wherein the pockets are divided in weight and air channels and comprise a non-quadratic but rectangular shape.

15. The weighted comforter according to claim 1, wherein a plurality of separate channels are sewn together to form the core layer.

16. The weighted comforter according to claim 1, wherein the inside of air channels comprises tubes, air-permeable tubes or meshed tubes.
